(19) United States
(12) Patent Application Publication
(10) Pub. No.: US 2023/0044169 A1
(43) Pub. Date: Feb. 9, 2023

(54) LIGHTING APPARATUS WITH MICROWAVE INDUCTION

(71) Applicant: Tiejun Wang, Lin'an City (CN)

(72) Inventor: Tiejun Wang, Lin'an City (CN)

(21) Appl. No.: 17/396,869

(22) Filed: Aug. 9, 2021

(51) Int. Cl. H05B 47/19; H05B 47/155; F21K 9/238; F21V 23/04; H04B 10/11; H04B 10/90

(52) U.S. Cl. CPC H05B 47/19; H05B 47/155; F21K 9/238; F21V 23/0435; H04B 10/11; H04B 10/90; F21Y 2115/10

(57) ABSTRACT

Disclosed embodiments provide a lighting apparatus with microwave induction. The microwave induction lamp emits electromagnetic waves through an antenna, such as a planar antenna. When a moving object enters the electromagnetic wave environment, the waveform is reflected and folded back and received by a microwave transceiver via the antenna and serves as a trigger signal. When the antenna receives the feedback waveform, a microcontroller-operated circuit activates a lighting device (e.g., a bank of light emitting diodes (LEDs)) in response to detecting the trigger signal. Disclosed embodiments use the trigger signal to turn the lighting device (lamps) on and off and further include a delay function, via a timer, to keep the lighting device activated for a predetermined period after detecting the trigger signal. In this way, a safe and efficient automatically activated lighting apparatus is provided.

### FIELD

The present invention relates generally to lighting control, and more particularly to a lighting apparatus with microwave induction.

### BACKGROUND

Proper lighting plays an important role in homes, workplaces, schools, and other locations. Insufficient lighting can create an unsafe environment, and can be unhealthy for people, causing additional eye strain. Automatically activated lights can help to mitigate these issues. Automatically activated lights are used in a variety of applications, both outdoors and indoors. These lights activate (turn on) based on detecting presence and/or motion of a person. This provides both safety and convenience, while also serving to conserve energy by deactivating (turning off) lights when not needed. As automatically activated lights are used with increasing popularity, it is desirable to have improved lighting apparatuses for automatic light activation.

### SUMMARY

In one embodiment, there is provided a lighting apparatus comprising: a lighting device; a microwave transceiver; a microwave antenna coupled to the microwave transceiver; a microcontroller; and a computer memory coupled to the microcontroller, wherein the computer memory includes instructions, that when executed by the microcontroller, cause the lighting apparatus to activate the lighting device for a predetermined period upon detecting a signal from the microwave antenna.

In another embodiment, there is provided a lighting apparatus comprising: an enclosure comprising an opaque portion and a translucent portion; a microwave transceiver disposed with in the enclosure; a microwave antenna disposed within the enclosure and coupled to the microwave transceiver; a lighting device disposed within the enclosure and configured and disposed such that light from the lighting device passes through the translucent portion of the enclosure; a microcontroller disposed within the enclosure; and a computer memory coupled to the microcontroller, wherein the computer memory includes instructions, that when executed by the microcontroller, cause the lighting apparatus to activate the lighting device for a predetermined period upon detecting a signal from the microwave antenna.

In another embodiment, there is provided a lighting system comprising: a plurality of lighting apparatuses, wherein each lighting apparatus comprises: a lighting device; a microwave transceiver; a microwave antenna coupled to the microwave transceiver; a microcontroller; a wireless communication interface coupled to the microcontroller; and a computer memory coupled to the microcontroller, wherein the computer memory includes instructions, that when executed by the microcontroller, activate the lighting device for a predetermined period upon detecting a signal from the microwave antenna, and broadcast a light activation message upon detecting the signal from the microwave antenna.

### BRIEF DESCRIPTION OF THE DRAWINGS

The structure, operation, and advantages of the present invention will become further apparent upon consideration of the following description taken in conjunction with the accompanying figures (FIGs). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Often, similar elements may be referred to by similar numbers in various figures (FIGs) of the drawing, in which case typically the last two significant digits may be the same, the most significant digit being the number of the drawing figure (FIG). Furthermore, for clarity, some reference numbers may be omitted in certain drawings.

FIG. 1 is a block diagram of an embodiment of the present invention.

FIG. 2 shows an embodiment of the present invention in a lightbulb form factor.

FIG. 3A shows an exemplary embodiment with two lights in an off configuration.

FIG. 3B shows an exemplary embodiment with a first light in an on configuration and a second light in an off configuration.

FIGS. 3C and 3D show an exemplary embodiment with two lights in an on configuration.

FIG. 3E shows an exemplary embodiment with a first light in an off configuration and a second light in an on configuration.

FIG. 4 shows a signal timing diagram in accordance with embodiments of the present invention.

FIG. 5 shows a flowchart indicating process steps for embodiments of the present invention.

FIG. 6 shows a flowchart indicating process steps for additional embodiments of the present invention.

FIGS. 7A and 7B show an exemplary embodiment with remote light activation in accordance with embodiments of the present invention.

### DETAILED DESCRIPTION

Disclosed embodiments provide a lighting apparatus with microwave induction. The microwave induction lamp emits electromagnetic waves through an antenna, such as a planar antenna. When a moving object enters the electromagnetic wave environment, the waveform is reflected and folded back and received by a microwave transceiver via the antenna and serves as a trigger signal. When the antenna receives the feedback waveform, a microcontroller-operated circuit activates a lighting device (e.g., a bank of light emitting diodes (LEDs)) in response to detecting the trigger signal. Disclosed embodiments use the trigger signal to turn the lighting device (lamps) on and off and further include a delay function, via a timer, to keep the lighting device activated for a predetermined period after detecting the trigger signal. In this way, a safe and efficient automatically activated lighting apparatus is provided.

Disclosed embodiments provide numerous advantages over other mechanisms for light activation such as infrared induction. Infrared induction is easily interfered with by various heat sources, light sources, radio frequency radiation, and hot air flow. Furthermore, passive infrared penetration is poor, and the infrared radiation of the human body is easily blocked. When the ambient temperature is close to the human body temperature, the detection and sensitivity are significantly reduced, sometimes causing the lights to not operate in an expected manner.

The microwave technique of disclosed embodiments has a longer sensing distance than an infrared sensor module, a wider angle of detection, and no dead zones. Furthermore, disclosed embodiments are not affected by lens condition, lens aging, ambient temperature, humidity, airflow, dust, noise, or other environmental factors, and has strong anti-interference ability. Disclosed embodiments can be used with a translucent portion (lens) comprised of; acrylic, glass, and/or thin non-metallic materials. In embodiments, an integrated microcontroller implements multiple digital filter algorithms for detecting microwave signals, providing higher accuracy and reduced false activations.

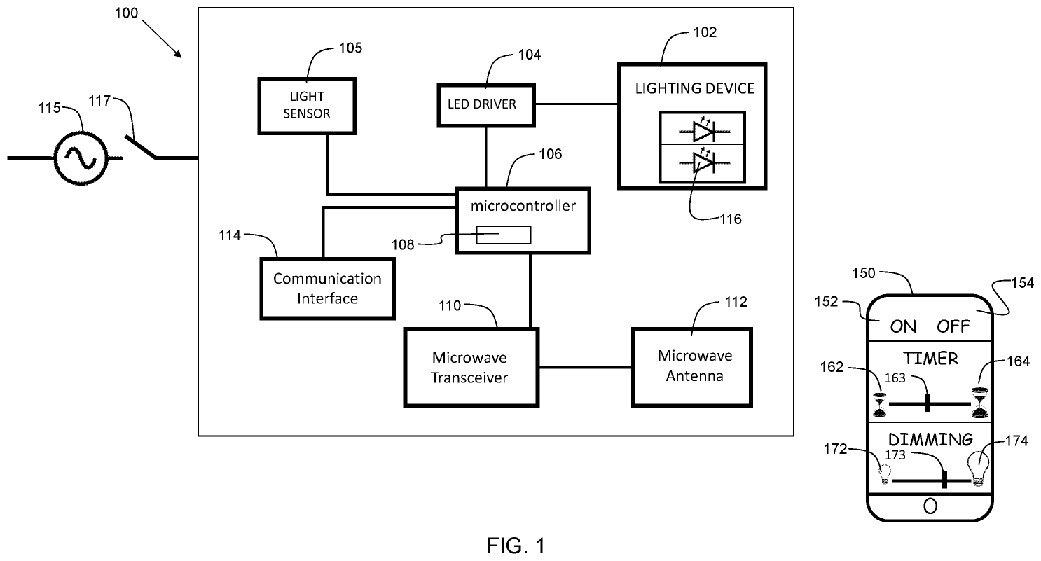

FIG. 1 is a block diagram of an embodiment of the present invention. Lighting apparatus 100 includes a lighting device 102. Lighting device 102 may include a plurality of light emitting diodes (LEDs), indicated generally as 116. The lighting device 102 is the light-producing element within the lighting apparatus 100. In some embodiments, lighting device 102 may comprise incandescent lights, fluorescent lights, and/or other suitable lighting types. In embodiments utilizing LEDs, the lighting apparatus 100 may further include an LED driver 104 coupled to the plurality of LEDs. The LED driver 104 carefully controls the current delivered to the LED light-emitting device 102.

Lighting apparatus 100 further includes a microcontroller 106. The microcontroller 106 includes an internal memory 108 that contains instructions which are executed by the microcontroller 106 in order to perform various functions in accordance with embodiments of the present invention.

A microwave transceiver 110 is coupled to the microcontroller 106. A microwave antenna 112 is coupled to the microwave transceiver 110. In some embodiments, the microwave antenna 112 is a planar antenna. A light sensor 105 is coupled to the microcontroller 106. In some embodiments, the light sensor 105 is configured to detect an ambient light condition. In some embodiments, the light sensor 105 may include a photoresistor or other suitable device. In embodiments, the microcontroller 106 only activates the lighting device 102 during conditions of ambient light below a predetermined level, where the ambient light level is determined by the light sensor 105. In other embodiments, the microcontroller 106 may activate the lighting device 102 independent of the ambient light level.

The lighting apparatus 100 may further include a wireless communication interface 114. In embodiments, the communication interface 114 may include Wi-Fi, Bluetooth, and/or Zigbee transceivers. The communication interface 114 may be used to communicate with a remote computing device 150. In embodiments, the remote computing device 150 may be a smartphone, tablet computer, laptop computer, wearable computer, or other suitable computing device.

Remote computing device 150 may execute an application (“app”) that provides a user interface for controlling the lighting apparatus 100. The user interface may include an ON button 152 and OFF button 154 for turning the lighting device 102 on or off, respectively. The remote computing device 150 may further provide a timer control 163. In embodiments, the timer control 163 is a slider or virtual slider implemented on a touchscreen that can be moved between a minimum time setting 162 and a maximum time setting 164. In embodiments, the minimum time setting is one minute and the maximum time setting is ten minutes. Other range limits are possible in disclosed embodiments. The control 163 may be set to an intermediate position, such as shown in FIG. 1, to configure an intermediate timer value (e.g., five minutes). In embodiments, the lighting device 102 deactivates (turns off) after the amount of time as specified by the timer value has elapsed.

The remote computing device 150 may further provide a dimmer control 173. In embodiments, the dimmer control 173 is a slider or virtual slider implemented on a touchscreen that can be moved between a minimum dimmer setting (minimum brightness) 172 and a maximum dimmer setting (maximum brightness) 174. Other lighting parameters such as correlated color temperature (CCT) may also be controlled by the remote computing device 150 in some embodiments.

In embodiments, the lighting apparatus 100 is powered by an alternating current (AC) power source 115. In some embodiments, a master switch 117 may be configured to enable or disable AC power to the lighting apparatus 100.

When the controls of the user interface on remote computing device 150 are invoked, data may be communicated from the remote computing device 150 to the microcontroller 106 via a wireless communication protocol such as Wi-Fi, Bluetooth, Zigbee, or other suitable protocol. The microcontroller, upon receiving the data, may adjust the functioning of the lighting device 102. In embodiments, the microcontroller implements a delay timer that starts counting down from a predetermined value (e.g., 300 seconds), each time a signal is received from microwave antenna that is indicative of motion/presence within a predetermined distance from the lighting device. The lighting apparatus 100 may be built into a lightbulb form factor, such as a BR-type lightbulb, an A-type lightbulb, and/or a PAR-type lightbulb. Thus, embodiments can include a lighting apparatus comprising: a lighting device; a microwave transceiver; a microwave antenna coupled to the microwave transceiver; a microcontroller; and a computer memory coupled to the microcontroller, wherein the computer memory includes instructions, that when executed by the microcontroller, cause the lighting apparatus to activate the lighting device for a predetermined period upon detecting a signal from the microwave antenna. In embodiments, the computer memory is a non-transitory computer-readable medium. The computer memory can include, but is not limited to, static random-access memory (SRAM), flash memory, read-only memory (ROM), and/or other suitable memory type.

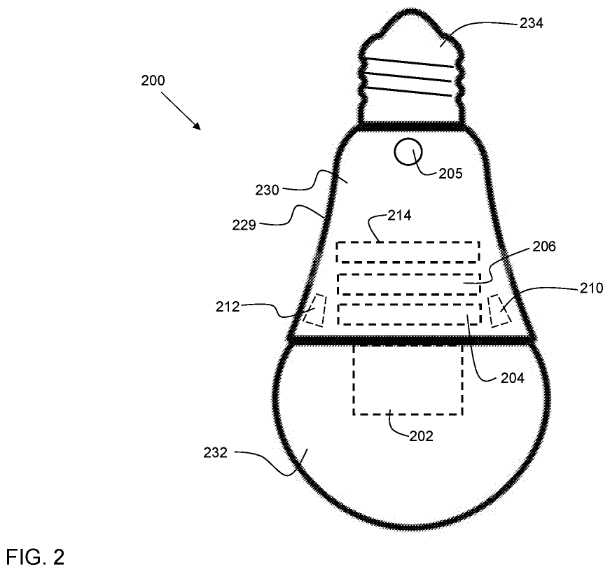

FIG. 2 shows an embodiment of the present invention in a lightbulb form factor. Lightbulb 200 comprises an enclosure 229. The enclosure 229 comprises an opaque portion 230 and a translucent portion 232. Disposed within the enclosure 229 is a microcontroller 206, which is coupled to LED driver 204. The LED driver 204 is coupled to LED array 202, which comprises a plurality of LEDs. The LED array is configured and disposed such that light emanating from the LED array 202 passes through translucent portion 232 of the enclosure 229. A microwave transceiver 210 and microwave antenna 212 are disposed within the enclosure 229 and coupled to microcontroller 206.

Lightbulb 200 further comprises light sensor 205 which may be used to detect ambient light levels. In some embodiments and/or modes of operation, the LED array 202 may only be activated when the ambient light is below a predetermined level. In embodiments, the microcontroller 206 reads a signal level that is modified based on a resistance that varies as a function of the light received by light sensor 205.

Lightbulb 200 may further comprise a screw terminal 234 on one end of the enclosure such that the lightbulb 200 may be installed in a standard lamp or light socket to utilize the function of microwave induction in order to automatically activate lights based on the presence and/or motion of a person, vehicle, animal, or other moving object.

Lightbulb 200 further includes wireless communication interface 214. In embodiments, the communication interface 214 may include Wi-Fi, Bluetooth, and/or Zigbee transceivers. The communication interface 214 may be used to communicate with a remote computing device such as a smartphone or tablet computer in order to configure and/or control operation of the lightbulb 200.

Embodiments can include a lighting apparatus comprising: an enclosure comprising an opaque portion and a translucent portion; a microwave transceiver disposed with in the enclosure; a microwave antenna disposed within the enclosure and coupled to the microwave transceiver; a lighting device disposed within the enclosure and configured and disposed such that light from the lighting device passes through the translucent portion of the enclosure; a microcontroller disposed within the enclosure; and a computer memory coupled to the microcontroller, wherein the computer memory includes instructions, that when executed by the microcontroller, cause the lighting apparatus to activate the lighting device for a predetermined period upon detecting a signal from the microwave antenna. Embodiments can further include a screw terminal on one end of the enclosure.

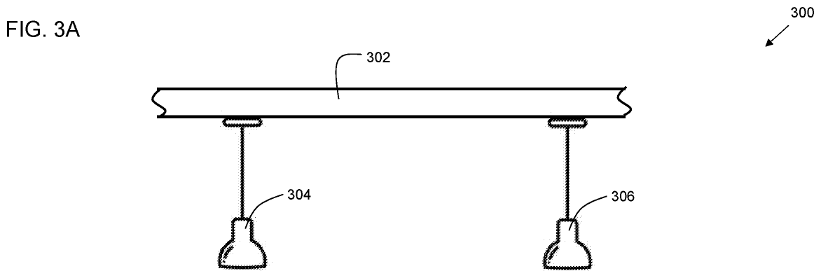

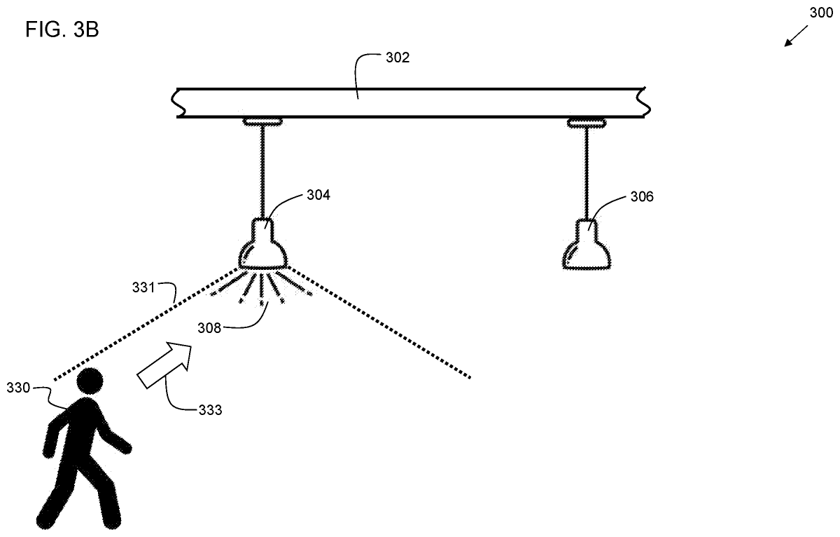

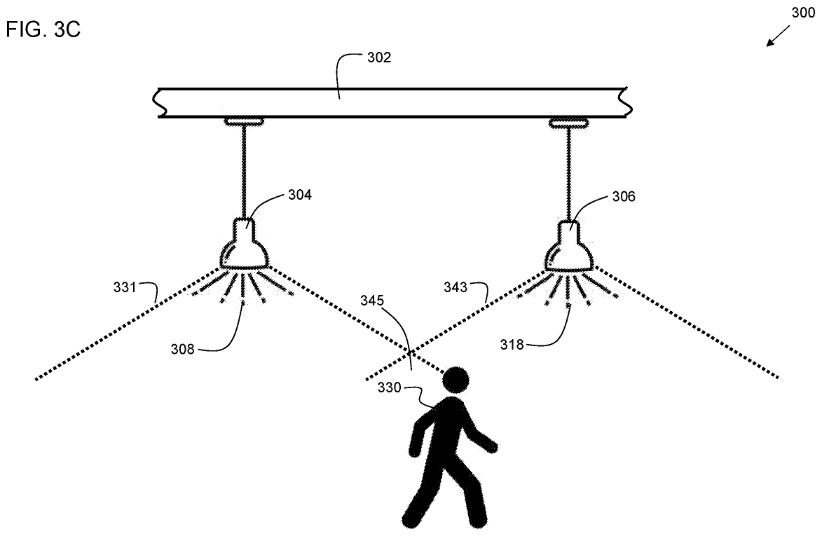

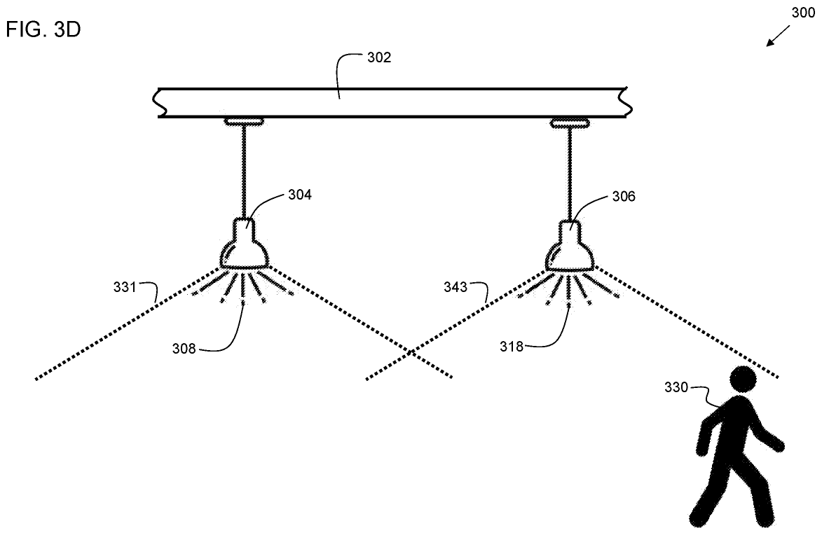

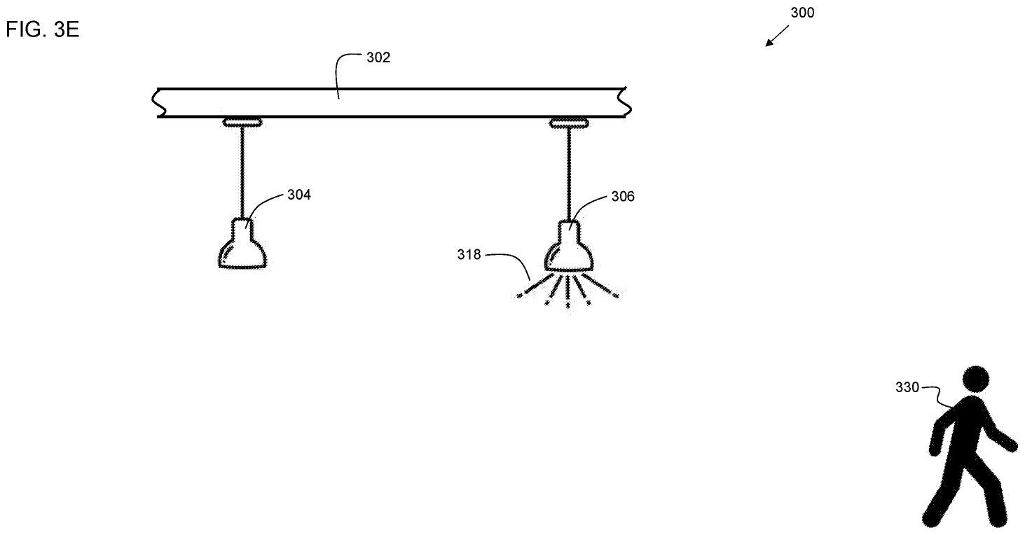

FIG. 3A shows an exemplary embodiment with two lights in an off configuration. In the example 300, a first light 304 and a second light 306 are suspended from a ceiling 302. Light 304 and light 306 each have a lighting apparatus such as shown in FIG. 1 and/or FIG. 2. As shown, both lights 304 and 306 are in a deactivated (off) configuration, and are not producing light.

Referring now to FIG. 3B, the embodiment is shown as a person 330 walks into the detection region 331 of the light 304. This causes a microwave signal 333 to be reflected from the person 330 back to the light 304, where the antenna (112 of FIG. 1) receives the signal. The signal is demodulated by the microwave transceiver (110 of FIG. 1) and an indication of the signal is received by the microcontroller 106. Upon receiving the indication, the microcontroller activates the light, indicated as 308. Referring now to FIG. 3C, as the person 330 continues walking, the person enters the detection region 343 of light 306, causing light 306 to activate, emitting light 318. In embodiments, the lights 304 and 306 may be configured to have a region of overlap 345, where both detection regions 331 and 343 overlap. Referring now to FIG. 3D, the person 330 has moved such that the person is within the detection region 343 of the light 306, but is no longer in the detection region 331 of light 304. However, light 304 remains activated, and continues to output light indicated by 308 until the delay timer expires. Referring now to FIG. 3E, the person 330 has continued to move away from the lights 304 and 306, and the light 304 has deactivated (turned off), while light 306 is still activated (on) and outputting light indicated by 318. After the delay timer for light 306 expires, both lights return to the off configuration as shown in FIG. 3A. Thus, the lights 304 and 306 detect presence using microwave induction in order to efficiently and conveniently activate lights when needed, and deactivate lights after a period of inactivity.

Thus, disclosed embodiments include a microwave motion sensor. A microwave motion sensor uses electro-magnetic radiation. It emits waves which are then reflected back to the microwave transceiver. The transceiver analyzes the waves that are bounced back. If there is an object or person moving in the detection region, these received microwaves are altered. The microwave transceiver is able to identify these changes and assert a trigger signal in response.

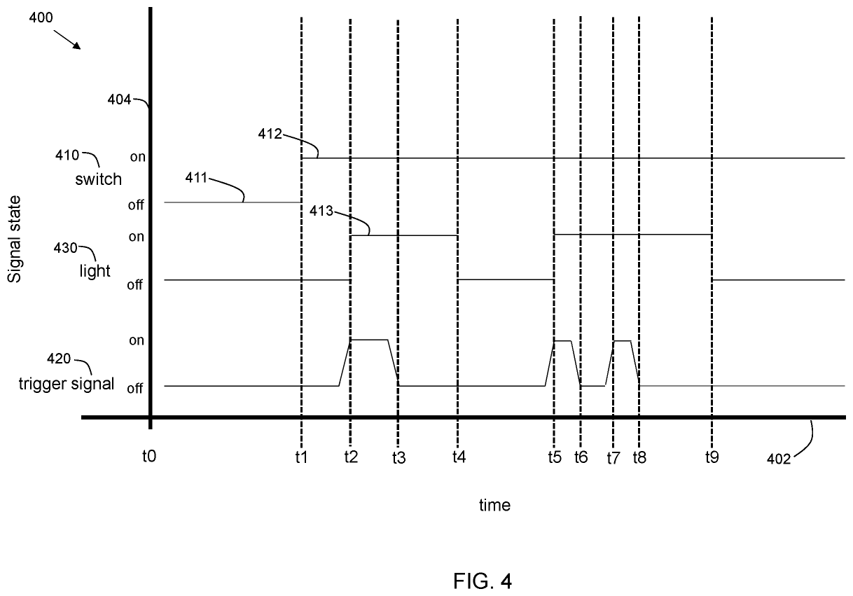

FIG. 4 shows a signal timing diagram 400 in accordance with embodiments of the present invention. Diagram 400 has a horizontal axis 402 representing time. Diagram 400 has a vertical axis 404 representing a signal state. At 410 a switch state is shown. In embodiments, the switch state can be the state of a switch such as 117 of FIG. 1. At time t0, the switch starts in an off position, as indicated by signal level 411. At time t1 the switch is set to on, as indicated by signal level 412. In embodiments, this may include a mechanical switch, and/or an activation via a user interface of a remote computing device such as utilizing ON button 152 as shown in FIG. 1.

At 420, a trigger signal state is shown. The trigger signal 420 may be generated by the microwave transceiver 110 in response to receiving a signal from microwave antenna 112. The signal can be generated when a person or object enters the detection region of a lighting apparatus (such as 331 of FIG. 3B). The change in received microwave signals that is caused by the person or object is detected by the microwave transceiver 110 and causes the microwave transceiver 110 to assert a signal that is detected by the microcontroller 106 (e.g., via a general-purpose input/output (GPIO) pin).

Time t2 represents an assertion of the trigger signal, which can be caused by a person entering the detection region of a lighting apparatus, such as depicted in FIG. 3B with person 330 entering detection region 331 of light 304. In response to the trigger signal 420 being asserted at time t2, the lighting device (e.g., 102 of FIG. 1) is activated, indicated by signal level 413. At time t3, the trigger signal 420 reverts to an off state. The microcontroller 106 implements a delay timer, such that the light remains illuminated for a predetermined time interval. Thus, the lighting device 102 remains on up to time t4, even though the trigger signal de-asserted at time t3. The duration between time t4 and t2 is a delay timer interval. In some embodiments, the delay timer interval may range between one minute and ten minutes. Other delay timer interval ranges are possible with disclosed embodiments. At time t5, the trigger signal 420 is asserted again (e.g., due to a person entering the detection region), and at time t6, the trigger signal 420 de-asserts to the off position (e.g., due to a person leaving the detection region). The light remains in an on state after time t6 due to the delay timer. Then at time t7, while the delay timer is still active, the trigger signal 420 is again asserted (e.g., due to another person entering the detection region). In embodiments, each trigger signal assertion restarts the delay timer. At time t8, the trigger signal 420 de-asserts to the off position (e.g., due to a person leaving the detection region). The light turns off after the expiry of the delay timer at time t9. The duration between time t8 and time t9 is the same as the duration between time t2 and time t3. Thus, as can be seen from diagram 400, assertions of the trigger signal 420 can reset the delay timer, potentially extending the amount of time that the light 430 remains in an on state. When the delay timer expires, the light 430 reverts to the off state, such as after time t9.

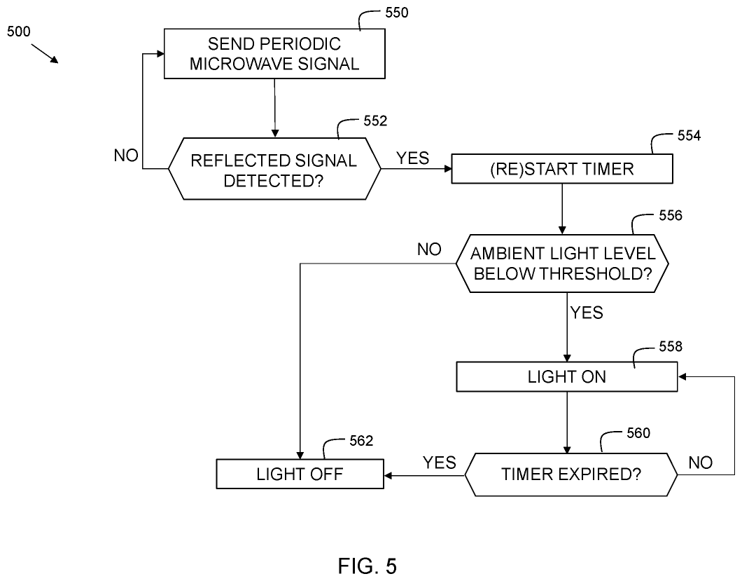

FIG. 5 shows a flowchart 500 indicating process steps for embodiments of the present invention. At 550, a periodic microwave signal is sent. This may be performed via microwave transceiver 110 and microwave antenna 112. In embodiments, the periodic microwave signal is sent at a rate ranging from once every 100 microseconds to once every 100 milliseconds. Other ranging intervals are possible in disclosed embodiments. At 552, a check is made to determine if a reflected microwave signal is detected. In embodiments, this may be performed via microwave transceiver 110 and microwave antenna 112. If no at 552, the process returns to 550. If yes at 552, the process continues to 554 where the delay timer is started, or restarted if it was already active. Optionally, at 556, a check is made to determine if the ambient light is below a predetermined threshold. In embodiments, this may be performed via light sensor 105. If no at 556, then the process continues to 562 where the light (e.g., lighting device 102) is maintained or set to an off state. If yes at 556, then the process continues to 558. At 558, the lights are turned on (e.g., activating lighting device 102). At 560 a check is made to see if the delay timer expired. If no at 560, then the process returns to 558 and the light remains on. If yes at 560, the light is shut off (e.g., deactivating lighting device 102).

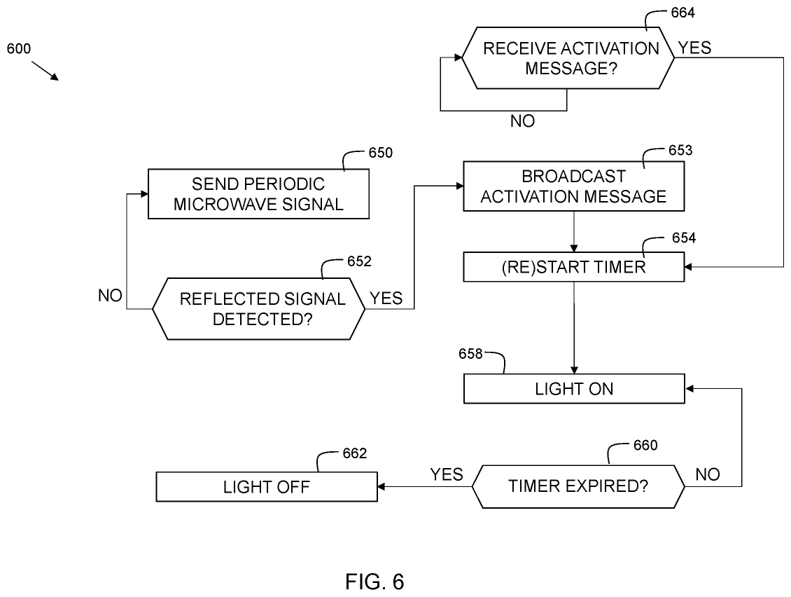

FIG. 6 shows a flowchart 600 indicating process steps for additional embodiments of the present invention. At 650, a periodic microwave signal is sent. This may be performed via microwave transceiver 110 and microwave antenna 112. In embodiments, the periodic microwave signal is sent at a rate ranging from once every 100 microseconds to once every 100 milliseconds. Other ranging intervals are possible in disclosed embodiments. At 652, a check is made to determine if a reflected microwave signal is detected. In embodiments, this may be performed via microwave transceiver 110 and microwave antenna 112. If no at 652, the process returns to 650. If yes at 652, the process continues to 656 where an activation message is broadcast. In embodiments, this may be performed via wireless communication interface (114 of FIG. 1). In embodiments, the activation message is broadcast via Bluetooth, Zigbee, Wi-Fi, or other short-range wireless communication protocol. The activation message serves to notify other nearby lighting apparatuses that this lighting apparatus has detected activity in its detection region. In embodiments, other nearby (e.g., within 2-10 meters) can proactively activate their respective lighting devices to more efficiently illuminate an area. The process continues to 654, where the delay timer is started, or restarted if it was already active. At 558, the lights are turned on (e.g., activating lighting device 102). At 560 a check is made to see if the delay timer expired. If no at 560, then the process returns to 558 and the light remains on. If yes at 560, the light is shut off (e.g., deactivating lighting device 102).

In the embodiment of FIG. 6, there are two ways that the light can be activated at step 658. The first technique is through reflected signal detection at 652. A second technique is via receiving an activation message at 664. If an activation message is received (e.g., from another nearby lighting apparatus, the microcontroller (106 of FIG. 1), in response to receiving the message, starts/restarts the delay timer. Thus, if yes at 664, the process continues to 654. If no at 664, then the process returns to 664, waiting and/or periodically checking for a received activation message from a nearby lighting apparatus. In embodiments, the activation message contains a unique identifier such as a MAC address and/or serial number of the lighting apparatus. In this way, a lighting apparatus can distinguish which lighting apparatus sent the activation message.

In embodiments, the lighting apparatus is configured to activate the lighting device for a predetermined period upon detecting a signal from the microwave antenna, and broadcast a light activation message upon detecting the signal from the microwave antenna. In other embodiments, the lighting apparatus is configured to receive a light activation message from another lighting apparatus from the plurality of lighting apparatuses and, in response to receiving the light activation message, activate the lighting device for the predetermined period

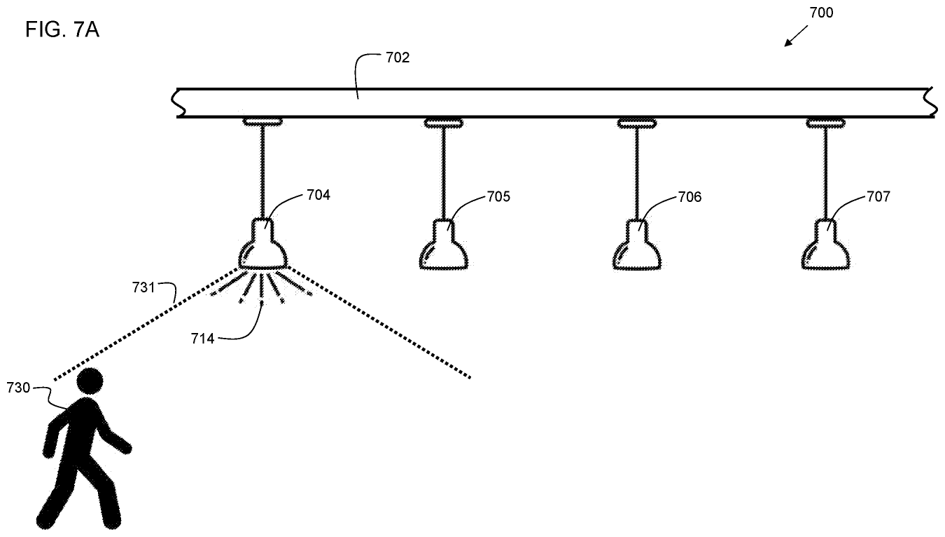

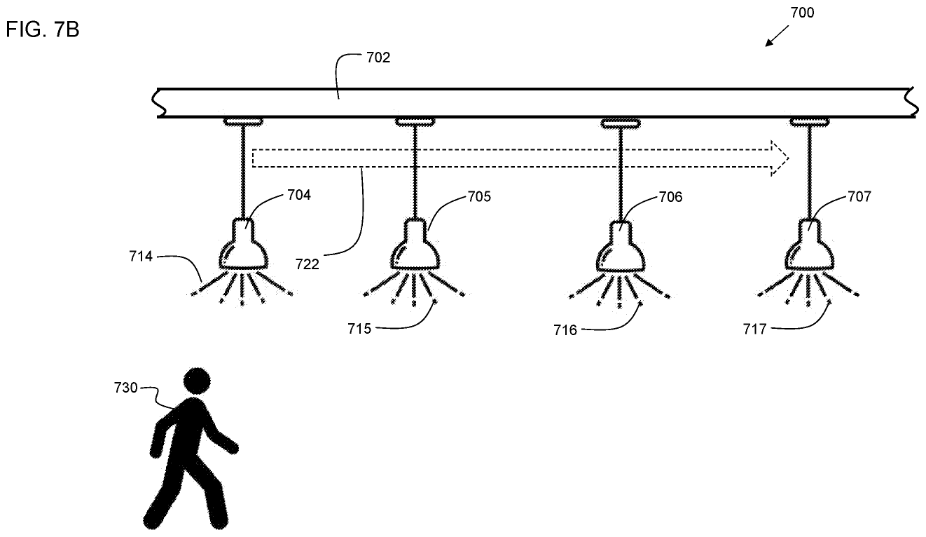

FIGS. 7A and 7B show an exemplary embodiment with remote light activation in accordance with embodiments of the present invention. Referring now to FIG. 7A, in the example 700, four lights, indicated as 704, 705, 706, and 707 are suspended from a ceiling 702. The lights 704-707 each have a lighting apparatus such as shown in FIG. 1 and/or FIG. 2. As shown in FIG. 7A, a person 730 walks into the detection region 731 of the light 704. This causes a microwave signal to be reflected from the person 730 back to the light 704, where the antenna (112 of FIG. 1) receives the signal. The signal is demodulated by the microwave transceiver (110 of FIG. 1) and an indication of the signal is received by the microcontroller 106. Upon receiving the indication, the microcontroller activates the light, indicated by 714. Each of the lights 704-707 utilizes activation messages as depicted in FIG. 6.

Referring now to FIG. 7B, when light 704 detects a reflected signal (652 of FIG. 6), it sends a broadcast activation message (653 of FIG. 6). The remaining lights (705, 706, and 707) receive the broadcast activation message 722 from light 704, and therefore illuminate before person 730 enters the corresponding detection regions for the remaining lights. In this way, the area is well lit in advance of the person 730 entering the detection regions for the remaining lights. Light 705 activates to illuminate as indicated by 715. Light 706 activates to illuminate as indicated by 716. Light 707 activates to illuminate as indicated by 717. Thus, this embodiment can be used to more efficiently provide automatic illumination for larger areas such as a large room or long hallway.

As can now be appreciated, disclosed embodiments provide improvements in automatically activated lighting. In embodiments, the activation of lighting devices (lamps, LEDs, etc.) is controlled by the microwave induction of moving objects, and the microwave induction function can be controlled (turned on or off) by Wi-Fi, Bluetooth, Zigbee, or other suitable communication protocol. In embodiments, the delay time to disable (turn off) the lighting devices is controllable via a remote computing device such as a smartphone via wireless communication. Thus, disclosed embodiments provide a lighting apparatus utilizing microwave induction lighting that provides improvement over infrared induction lighting and ordinary lighting lamps, as the microwave induction can sense a longer distance and a wider range, thereby providing improved safety, convenience, and efficiency.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A lighting apparatus comprising:
a lighting device;
a microwave motion sensor, the microwave motion sensor comprising:
a microwave transceiver; and
a microwave antenna coupled to the microwave transceiver;
a microcontroller; and
a computer memory coupled to the microcontroller, wherein the computer memory includes instructions, that when executed by the microcontroller, cause the lighting apparatus to activate the lighting device for a predetermined period upon detecting a signal from the microwave motion sensor.

2. The lighting apparatus of claim 1, wherein the lighting device comprises a plurality of LEDs.

3. The lighting apparatus of claim 2, further comprising an LED driver coupled to the plurality of LEDs.

4. The lighting apparatus of claim 1, further comprising a wireless communication interface.

5. The lighting apparatus of claim 4, wherein the wireless communication interface comprises a Wi-Fi transceiver.

6. The lighting apparatus of claim 4, wherein the wireless communication interface comprises a Bluetooth transceiver.

7. The lighting apparatus of claim 4, wherein the wireless communication interface comprises a Zigbee transceiver.

8. A lighting apparatus comprising:
an enclosure comprising an opaque portion and a translucent portion;
a microwave motion sensor disposed within the enclosure, the microwave motion sensor comprising:
a microwave transceiver; and
a microwave antenna coupled to the microwave transceiver;
a lighting device disposed within the enclosure and configured and disposed such that light from the lighting device passes through the translucent portion of the enclosure;
a microcontroller disposed within the enclosure; and
a computer memory coupled to the microcontroller, wherein the computer memory includes instructions, that when executed by the microcontroller, cause the lighting apparatus to activate the lighting device for a predetermined period upon detecting a signal from the microwave motion sensor.

9. The lighting apparatus of claim 8, wherein the lighting device comprises a plurality of LEDs.

10. The lighting apparatus of claim 9, further comprising an LED driver coupled to the plurality of LEDs.

11. The lighting apparatus of claim 8, further comprising a wireless communication interface.

12. The lighting apparatus of claim 11, wherein the wireless communication interface comprises a Wi-Fi transceiver.

13. The lighting apparatus of claim 11, wherein the wireless communication interface comprises a Bluetooth transceiver.

14. The lighting apparatus of claim 11, wherein the wireless communication interface comprises a Zigbee transceiver.

15. The lighting apparatus of claim 8, further comprising a screw terminal on one end of the enclosure.

16. A lighting system comprising:
a plurality of lighting apparatuses, wherein each lighting apparatus comprises:
a lighting device;
a microwave motion sensor, the microwave motion sensor comprising:
a microwave transceiver; and
a microwave antenna coupled to the microwave transceiver;
a microcontroller;
a wireless communication interface coupled to the microcontroller; and
a computer memory coupled to the microcontroller, wherein the computer memory includes instructions, that when executed by the microcontroller, activate the lighting device for a predetermined period upon detecting a signal from the microwave motion sensor, and broadcast a light activation message upon detecting the signal from the microwave motion sensor.

17. The lighting system of claim 16, wherein the computer memory further comprises instructions, that when executed by the microcontroller, receive a light activation message from another lighting apparatus from the plurality of lighting apparatuses, wherein the light activation message includes a MAC address; and, in response to receiving the light activation message, activate the lighting device for the predetermined period.

18. The lighting system of claim 16, wherein the wireless communication interface comprises a Wi-Fi transceiver.

19. The lighting system of claim 16, wherein the wireless communication interface comprises a Bluetooth transceiver.

20. The lighting system of claim 16, wherein the wireless communication interface comprises a Zigbee transceiver.
